(19) United States
(12) Patent Application Publication
(10) Pub. No.: US 2025/0085528 A1
(43) Pub. Date: Mar. 13, 2025

(54) POD-BORNE LASER WEAPON

(71) Applicant: COMPAGNIE INDUSTRIELLE DES LASERS CILAS, ORLEANS (FR)

(72) Inventors: Jean-Eucher MONTAGNE, ORLEANS (FR); David SABOURDY, ORLEANS (FR); Benjamin FORESTIER, ORLEANS (FR)

(21) Appl. No.: 18/730,615

(22) PCT Filed: Jan. 20, 2023
(86) PCT No.: PCT/EP2023/051321

§ 371 Date: Jul. 19, 2024

(30) Foreign Application Priority Data
Jan. 21, 2022 (FR) FR2200479

(51) Int. Cl. G02B 26/08; F41A 23/24; F41H 13/00

(52) U.S. Cl. CPC G02B 26/0816; F41H 13/0062; F41A 23/24

(57) ABSTRACT

A laser weapon comprising a pod, a device for orienting said pod, and at least one laser effector that emits a laser beam, the laser effector successively comprising, in the direction of propagation of the laser beam, a laser source, a first optical deflector, which deflects the laser beam, and a lens for focusing the laser beam, the lens supported by the pod. The laser weapon also comprises a controller that controls the device for orienting the pod and the first optical deflector. The laser effector also comprises a second optical deflector configured to deflect the laser beam, the second optical deflector is supported by the pod and positioned after the lens in the direction of propagation of the laser beam. The second optical deflector is controlled by the controller.

### CROSS-REFERENCES TO RELATED APPLICATIONS

This application is a national phase of International Patent Application No. PCT/EP2023/051321, filed on Jan. 20, 2023, which claims the benefit of French Patent Application No. 2200479, filed on Jan. 21, 2022, the entire disclosures of which are incorporated herein by way of reference.

### FIELD OF THE INVENTION

The field of the invention is that of weaponry, and more precisely of weapons emitting a high-power laser beam to destroy a target.

### BACKGROUND OF THE INVENTION

Flying objects such as drones can pose a number of security problems. They can be used by armed forces in conflict situations for intelligence purposes, or they can carry weapons or explosive charges and be used for aggressive purposes. Security forces therefore need to be able to destroy such flying objects, which can pose a threat. The small size, agility and low cost of such flying objects, enabling them to be deployed in large numbers, mean that the weapons traditionally used for anti-aircraft warfare are often unsuitable. New weapons systems have been developed specifically for destroying such flying objects.

A weapon has thus been proposed for focusing a high-power laser beam on a flying object. This laser beam, by heating a point on the flying object, can lead to its destruction.

The destruction of a flying object by such a laser beam requires a duration of around ten seconds, during which the beam must be focused on a single point on the flying object. Adapting the characteristics of the laser beam, and in particular its power, makes it possible to reduce this time, but it has been found that, above a certain power level, it is no longer cost-effective to achieve a significant reduction in the time required to destroy a flying object by further increasing the power emitted.

This relatively long period during which the laser weapon must be focused on a single flying object can lead to difficulties in the event of a simultaneous threat from a plurality of flying objects. In such a case, the weapon will have to destroy each flying object in turn, and in some cases will be unable to destroy them all.

To facilitate the successive destruction of several flying objects, the laser weapon should be able to move very quickly from one target to another. The means of directing the laser beam to focus on a target must therefore be extremely responsive and efficient.

To further increase the destruction capacity of a plurality of flying objects, it is possible to multiply the number of laser weapons deployed. However, such a solution involves high costs.

The present invention aims to overcome these disadvantages of the prior art.

In particular, one aim of the invention is to provide such a laser weapon with improved efficiency compared with solutions of the prior art.

One particular objective, in at least some embodiments, is to provide such a laser weapon in which systems for directing the laser beam to point and focus that laser beam on a target are improved.

A further aim, in at least some embodiments, is to provide such a laser weapon with improved effectiveness in neutralizing multiple targets simultaneously and/or successively.

A further aim, in at least some embodiments, is to provide such a laser weapon whose production, implementation and/or operating cost can be reduced, compared with solutions of the prior art.

### SUMMARY OF THE INVENTION

These objectives, and others that will become clearer later on, are achieved using a laser weapon comprising a pod, means for orienting this pod, and at least one laser effector capable of emitting a laser beam, the laser effector successively comprising, in the direction of propagation of the laser beam:
a laser source,
first optical deflection means, capable of deflecting the laser beam,
a lens for focusing the laser beam, that lens being carried by the pod,
   said laser weapon comprising control means controlling the pod orientation means and said first optical means for deflecting said laser effector. According to the invention, this laser effector comprises second optical deflection means capable of deflecting the laser beam, these second optical deflection means being carried by the pod and placed after the lens, in the direction of propagation of the laser beam, these second optical deflection means being controlled by the control means.

With the second optical deflection means, the output laser beam emitted by the laser end effector can be oriented over large angular ranges relative to the position of the pod. The laser weapon thus provides faster, more efficient and more reliable means of aiming the output laser beam at a target. Furthermore, as the orientation of the laser beam can vary with respect to the direction of the pod, the pod can carry other weapons, or other laser effectors, which can be pointed at different targets.

Preferably, the second optical deflection means are able to enable controlled beam deflection over an angular range greater than 3°, and preferably greater than 5°, and even more preferably greater than 10°.

In this application, the angular range is considered to be the maximum angle formed between two possible beam orientations. This angular range is preferably centered on the optical axis of the beam exiting the lens, which is referred to in this application as the “lens optical axis”. Furthermore, this angular range preferably allows the beam to be deflected in all directions, around the optical axis of the lens. In some cases, it is even possible to achieve a controlled beam deflection of several tens of degrees. Such a large deflection allows the beam to be directed at targets, irrespective of the position of the pod.

Preferably, the first optical deflection means are capable of controlled beam deflection over an angular range of less than 5 milliradians.

This deflection must be small, so as not to interfere with the passage of the beam through the lens. However, such a deflection can be achieved very quickly and precisely.

In an advantageous embodiment, these second optical deflection means comprise a number of prismatic blades capable of rotating about the optical axis of the lens.

Such means of deflection are known in particular as diasporameters or Risley prisms. The rotation of prismatic blades can easily be motorized, for quick and easy controlled deflection of a beam.

According to another possible embodiment, these second optical deflection means may comprise one or more movable reflectors.

Such optical deflection means, comprising movable mirrors, can enable the beam to be deflected by very large amplitudes, for example by several tens of degrees.

In an advantageous embodiment, the laser effector comprises an optical fiber capable of conducting the laser beam between the laser source and the first deflection means.

In this case, the laser effector's first deflection means are carried by the pod, and the laser source of the laser effector is located outside the pod.

One of the advantages of this solution is that it reduces the mass and volume of the pod.

In an advantageous embodiment, the pod orientation means comprise a pod-carrying turret capable of pivoting the pod about two mutually perpendicular axes.

Such a turret is commonly used to orient a pod quickly and efficiently. In addition to the laser effector, this pod can carry other elements such as weapons or sensors, which can be oriented by the pod. In this case, the beam emitted by the laser effector can be oriented in a direction independent of the orientation of these weapons or sensors, thanks to the second optical deflection means.

In a particularly advantageous embodiment, the laser weapon comprises at least two separate laser effectors, each of which comprises at least one lens carried by the pod, at least one of which comprises the second optical beam deflection means.

These second optical beam deflectors enable the different laser effectors, carried by the same pod, to be pointed in independent directions and to aim at different targets. Preferably, the separate laser effectors each feature first and second optical beam deflection means as described above. It should be noted, however, that these separate laser effectors may, in certain configurations, share certain components, such as the same laser source. They are nonetheless considered to be distinct in that they enable separate beams to be emitted.

Advantageously, the lenses of the separate laser effectors are oriented on said pod along optical axes that are not parallel to each other.

This increases the overall angular range over which the various laser effectors carried by a single pod can emit laser beams.

### BRIEF DESCRIPTION OF THE DRAWINGS

The invention will be better understood upon reading the following description of preferential embodiments, given by way of a simple figurative, non-limiting example, and accompanied by the figures, in which:

FIG. 1 is a schematic representation of a laser weapon according to one embodiment of the invention.

FIG. 2 is a diagram schematically representing the components of the laser weapon of [FIG. 1].

FIG. 3 is a diagram schematically representing the components of the laser effector laser weapon of [FIG. 1].

FIG. 4 is a schematic representation of a laser weapon according to another embodiment of the invention.

FIG. 5 is a schematic representation of a laser weapon according to yet another embodiment of the invention.

### DETAILED DESCRIPTION OF THE PREFERRED EMBODIMENTS

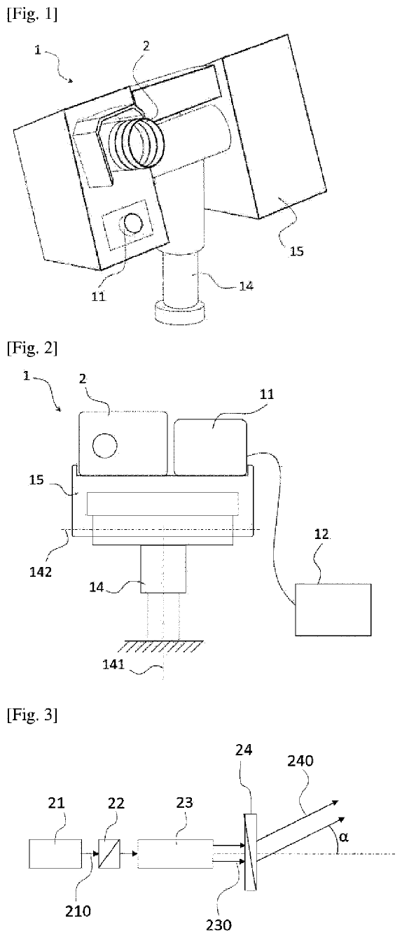

FIG. 1 shows a perspective view of a laser weapon 1 according to one embodiment of the invention, whose main components are represented schematically by the diagram in [FIG. 2].

This laser weapon 1 comprises an orientable pod 15, which carries some of the components of the laser weapon 1. This pod is controlled, i.e. its orientation can be modified in response to instructions from control means or a controller. In the embodiment shown in [FIG. 1], this pod 15 consists of a metal housing. In other possible embodiments, a pod according to the invention can be constituted by any support that can be oriented in different directions, and capable of carrying at least part of a laser effector.

This pod 15 is advantageously carried by an articulated turret 14 which enables the pod 15 to be oriented in a desired direction, in response to instructions from control means. In the embodiment shown, the turret 14 is articulated along two axes: a substantially vertical axis 141 and a substantially horizontal axis 142. By these means, the orientation of the pod 15 it carries, relative to the support on which the turret 14 is attached, can be varied in all directions in space.

The movements of the turret 14 components are advantageously controlled by servomotors capable of rapidly modifying the angular position of the pod 15, in response to instructions from control means. The turret 14 thus enables the orientation of pod 15 to be modified in a fairly reactive and efficient way, with a very wide angular amplitude. These movements of the components of the turret 14, the pod 15 and the components carried by the pod 15 do, however, involve appreciable inertial forces, due to the masses of these components. These inertial forces limit the speed of pod movements.

According to the invention, the pod 15 carries at least part of a laser effector 2, capable of emitting a focused laser beam capable of damaging or destroying a distant target.

By modifying the orientation of the pod 15, the movements of the turret 14 components modify the orientation of the focused laser beam emitted by the laser effector 2, with a very large angular amplitude, in order to direct this focused laser beam towards its target. For example, the precision of the pod orientation obtained by the movements of the turret components is generally of the order of a few hundredths of a milliradian.

However, the precision of the orientation obtained by the moving of the components of the turret 14 is insufficient to ensure precise aiming of the beam emitted by the laser effector 2 at a small target several hundred meters away.

The laser effector 2 is itself made up of several components, which are shown schematically in [FIG. 3]:
a laser source 21 emits an initial laser beam 210,
first optical deflection means 22 direct this initial laser beam 210,
a lens 23 focuses this initial laser beam 210, to form the focused laser beam 230,
second optical deflection means 24 direct the focused laser beam 230 to form the output laser beam 240.

The laser source 21 that emits the initial laser beam 210 may comprise a laser diode or any laser cavity capable of producing a beam and, where appropriate, one or more amplifiers capable of amplifying this beam. Such a laser source is well known to the person skilled in the art. It is advantageously controlled, i.e. it emits a laser beam with desired characteristics in response to instructions from control means.

Advantageously, the laser source 21 can be designed to emit the initial laser beam 210 in an optical fiber, which can easily carry the initial laser beam 210.

Thanks to such an optical fiber, the laser source 21 can be distanced from the other components of the laser effector 2. This makes it possible, for example, for most of the components of the laser effector 2 to be carried by the pod 15, while the laser source 21 is located outside the pod 15. In this case, the laser source 21 is connected to the other components of the laser effector 2 via the optical fiber.

According to the invention, the initial laser beam 210 passes through first optical deflection means 22 before being focused by lens 23. These first optical deflection means 22 are advantageously designed to precisely orient the output laser beam 240 within a restricted angular range. They are advantageously controlled, i.e. they enable the orientation of the output laser beam 240 to be varied in response to instructions from control means.

These first optical deflection means 22 may, for example, consist of a diasporameter, or Risley prisms, made up of several prismatic blades that can rotate relative to each other around the optical axis. Such optical deflection means are known per se for laser beam orientation.

In another possible embodiment, these first optical deflection means 22 can form an optical device for changing the direction of propagation of a light beam which comprises, in the direction of propagation of the light beam, a group of generally divergent optics and a group of generally convergent optics, the group of generally divergent optics containing, in the direction of propagation of the light beam, a fixed optic and an optical module comprising at least one movable optical element capable of modifying the direction of propagation of the light beam emerging from the group of generally divergent optics. Such optical devices are known to the person skilled in the art and are described, for example, in document FR3064758A1.

In such a case, the first optical deflection means 22 may have the effect of angularly deflecting the initial laser beam 210 before it is introduced into the lens 23, and/or of shifting the initial laser beam 210 away from the optical axis of the lens 23. In both cases, the first optical deflection means 22 have the effect of angularly deflecting the focused laser beam 230 exiting the lens 23, and therefore the output laser beam 240.

Such angular deflection of the output laser beam 240 can be achieved by the first optical deflection means 22 in accordance with a command from the control means, very precisely and with a very high degree of responsiveness. The initial laser beam 210 is advantageously small in diameter. The movable optical components of the first optical deflection means 22 can therefore be small in size, and exhibit very little inertia during their movements. This means they can be moved very quickly.

On the other hand, the angular deflection of the output laser beam 240 obtained by the first optical deflection means 22 can only have a very limited amplitude. A deflection of too great an amplitude would not allow the initial laser beam 210 to pass correctly through the lens 23. By way of illustration, such first optical deflection means 22 may enable the output laser beam 240 to be deflected by an angle on the order of milliradians, with an accuracy on the order of hundredths of a milliradian.

The combination of the controlled orientation of the pod 15 by the turret 14, which has a very large amplitude but is relatively inaccurate and relatively unresponsive, and the controlled deflection, by the first optical deflection means 22, of the focused laser beam 230 relative to the pod 15, which is small in amplitude but very precise and responsive, enables the laser weapon 1 to aim the output laser beam 240 emitted by the laser effector 2, over a large angular amplitude but very precisely, so that it hits a small, distant moving target.

After passing through the first optical deflection means 22, the laser beam passes through an lens 23, which consists of a succession of optics capable of focusing the output laser beam 240 at a desired distance. The operation of such a lens is in itself known to the person skilled in the art. The optics making up this lens are preferably movable relative to one another to enable the focal length of the lens to be adjusted according to the distance of the target on which the beam is to be focused. This lens is advantageously controlled, i.e. it can impart variable focusing characteristics to the beam in response to instructions from control means.

So that this focused laser beam 230 can be focused on a distant point, it preferably has a much larger diameter than the diameter of the initial laser beam 210.

According to the invention, second beam-deflecting optical means 24 capable of modifying the orientation of the focused laser beam 230 are provided at the output of the lens 23. These second optical beam deflection means 24 are advantageously controlled, i.e. they enable the orientation of the output laser beam 240 to be varied in response to instructions from control means.

As mentioned above, these second optical deflecting means 24 are generally not required to orient the focused laser beam 230. Indeed, the combination of the movements of the turret 14 and the first optical deflection means 22 is generally sufficient to direct this focused laser beam 230 over a wide angular range and with great accuracy, in order to reach its target.

These second optical deflection means 24 may, for example, consist of a diasporameter, or Risley prisms, made up of two prismatic blades that can rotate relative to each other around the optical axis. Such deflection means are known, in themselves, to enable the controlled deflection of a beam.

According to another possible embodiment, these second optical deflection means can be made up of a set of reflectors that can be moved relative to one another, such as movable mirrors, whose position is controlled. It is also possible for these second optical deflecting means to comprise a combination of several different types of components, for example pivoting prismatic blades and movable mirrors.

These second optical deflection means 24 are advantageously designed to allow an amplitude of deflection of the output beam 240, relative to the optical axis of the lens, of an angle α greater than 3°, and preferably greater than 5°. It is even possible, in preferred embodiments, for these second optical deflection means to allow a deflection amplitude of the output beam 240 of an angle α greater than 10 or 20°.

As these second optical deflection means 24 are advantageously located after all the laser beam-shaping optics, they can have a large deflection angle without inducing any penalizing distortion on the output beam 240.

The laser weapon 1 advantageously includes a detection and aiming system 11. Such a detection and pointing system 11, which is known per se, may comprise, for example, one or more radars, one or more LIDARs and one or more cameras. It detects potential targets, precisely measures their position and tracks it. This detection and pointing system 11 can be associated with a human-machine interface 12 which can, for example, enable an operator to view potential targets on a screen. The operator can then choose whether to destroy one of these targets.

In addition, this detection and pointing system can include control means for controlling the laser source 21, the first optical deflection means 22, the lens 23 and the second optical deflection means 24.

In the embodiment shown, at least some of the sensors of the detection and pointing system 11 are carried by the pod 15. However, it is possible that other components of this detection and pointing system 11 are not carried by the pod 15. In other embodiments, none of the components of the detection and pointing system 11 are carried by the pod 15. This detection and pointing system 11 then operates independently of the position of the pod 15.

If requested by the operator, via the human-machine interface, the detection and pointing system 11 can point the laser effector 2 in the direction of a target, to enable this laser effector 2 to emit a laser beam focused on this target, with a view to destroying it. To achieve this, the detection and aiming system 11 comprises control means controlling the movements of the turret 14, the first optical deflection means 22, the lens 23 and the second optical deflection means 24, in order to focus the output laser beam 240 on the target.

The combination of movements of the pod 15, thanks to the turret 14, and beam deflections by the first optical deflection means 22 and the second optical deflection means 24 provides several advantages.

In this way, the detection and aiming system 11, which controls these various means of orienting the output beam, can both modify the direction of the laser beam over a wide angular range, in particular with the aid of the movements of the pod 15, and correct, in particular with the aid of the first, more precise optical deflection means, the high uncertainties linked to the orientation of the pod 15 by the turret 14, in order to ensure precise aiming at the target.

In addition, the combination of the means for orienting the output laser beam 240 provided by the turret 14 and by the second optical deflection means 24 advantageously improves the time for a significant angular displacement of the output laser beam 240, for example to pass from one target to another, and therefore optimizes the time for successive destruction of a plurality of targets by the laser weapon.

The second optical deflection means 24, which are placed on a focused laser beam 230 with a large diameter, are formed by components whose size, and therefore weight, are relatively large. These components thus have a greater inertia when set in motion than the smaller components of the first optical deflection means 22. As a result, these second optical deflection means 24 have a longer reaction time than the first optical deflection means 22. However, this reaction time is shorter than that of the turret 14, which reduces the overall reaction time of the laser weapon 1, for example when switching from one target to another.

Finally, the combination of these three means of orienting the output laser beam 240 improves the reliability of the laser weapon, in particular by enabling the laser beam to be oriented even in a degraded situation in which a malfunction of the turret 14 would reduce its precision or speed of orientation, or even prevent any movement of the pod 15. The second optical deflection means 24, by allowing the output laser beam 240 to be oriented relative to the position of the pod 15, over a relatively large amplitude, would enable the laser weapon 1 to continue destroying targets.

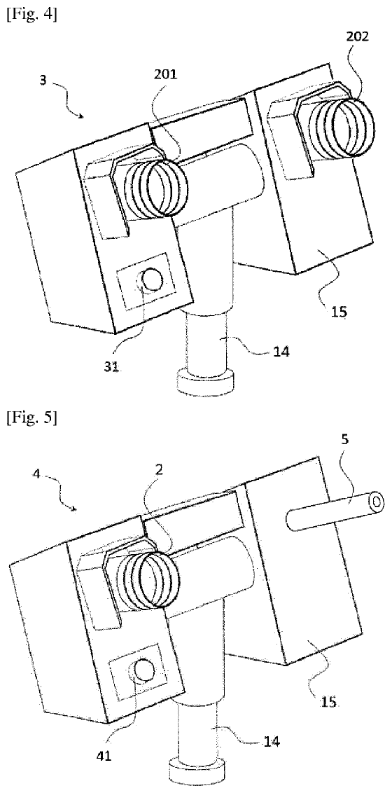

FIG. 4 is a schematic representation of a laser weapon 3 according to another embodiment of the invention.

This laser weapon comprises a orientable pod 15, which is carried by an articulated turret 14. This pod and turret are advantageously identical or virtually identical to those of the laser weapon 1 presented previously. In the embodiment shown, this pod 15 carries two separate laser effectors 201 and 202. At least a first of these laser effectors 201 is of the type shown in [FIG. 3], and comprises a laser source, first optical deflection means, a lens, and second optical deflection means. In this way, the output laser beam emitted by this laser effector can be oriented, in particular by the second deflection means, independently of the movements of the pod 15.

In some embodiments, the second laser effector 202 may not have any second optical deflection means. In such a case, the orientation of the output beam emitted by this second laser effector is achieved solely by the combination of the orientation means provided by the turret, which ensure its orientation over a large angular range, and by the second optical deflection means, which ensure its precise orientation over a small angular range.

Preferably, however, the second laser effector 202 is, like the first laser effector 201, of the type shown in [FIG. 3], and comprises a laser source, first optical deflection means, a lens, and second optical deflection means. In this way, each of the two laser effectors can emit a laser beam that can be oriented over an angular range of more than 6°, and preferably more than 10°, relative to its positioning axis on the pod.

According to a preferred solution, the optical axes of the first laser effector 201 and the second laser effector 202 may not be parallel, but instead form an angle which may, advantageously, be 10° to 20°. Thanks to the optical deflection means, each of the laser effectors can direct its beam within an angular zone centered on its optical axis, for a given position of the pod. Due to the divergent beams, the angular zones of the first laser effector 201 and the second laser effector 202 do not overlap, but are adjacent to each other, enabling simultaneous aiming at several targets at a distance from each other. However, it is advantageous if these angular zones partially overlap. Thus, if pod 15 is positioned so that a target is placed in the overlap area of the angular zones of a plurality of laser effectors, these laser effectors can simultaneously aim at the same target, which can facilitate its destruction.

The laser weapon 3 advantageously includes a detection and aiming system 31 similar to the detection and aiming system 11 described above, which enables potential targets to be detected, and their position to be precisely measured and tracked. In this embodiment, the detection and pointing system 31 comprises control means for controlling the orientation means of the pod 15 and the laser source, the first optical deflection means, the lens and the second optical deflection means of each of the laser effectors 201 and 202.

When this detection and pointing system 31 detects a plurality of targets simultaneously, it can place the pod 15 in a position chosen to allow each of the laser effectors 201 and 202 to be pointed in the direction of one of the targets, taking into account the possible deflection amplitudes of each of these laser effectors. If possible, this pod position is chosen so that each of the output beams emitted by one of the laser effectors 201 and 202 can be moved around its aiming axis, in order to track its target.

The detection and pointing system 31 then controls the second optical deflection means of the first laser effector 201, and if necessary those of the second laser effector 202, to direct their beams towards the separate targets. Finally, the detection and pointing system 31 controls the first optical deflection means of each of the laser effectors 201 and 202, to precisely point their beams at separate targets.

Like the detection and pointing system 11, the detection and pointing system 31 can be combined with a man-machine interface to enable an operator to decide whether or not to destroy each target.

The independence of the orientation of each of the beams emitted by the first and second laser effectors, thanks to the second optical deflection means with which at least one of these laser effectors is equipped, therefore enables the laser weapon 3 to destroy or damage several targets simultaneously. Such a weapon is therefore significantly more effective, for example, against a coordinated attack by several drones. However, such a weapon is less expensive than a combination of two laser weapons of the type shown in [FIG. 1]. Indeed, the cost of the turret 14 and any carrier vehicle represents a significant proportion of the cost of such a laser weapon.

In other possible embodiments, more than two laser effectors can be carried by the same orientable pod, enabling a greater number of targets to be aimed at simultaneously, if these laser effectors can be oriented independently of one another. The optical axes of the lenses of these laser effectors can advantageously not be parallel to each other.

In yet another possible embodiment, one or more laser effectors and one or more conventional weapons can be carried on the same orientable pod.

By way of example, [FIG. 5] shows a laser weapon 4 comprising an orientable pod 15, which is carried by an articulated turret 14. This pod and turret are advantageously identical or virtually identical to those of the laser weapon 1 presented previously. In the embodiment shown, this pod 15 carries a laser effector 2, which is advantageously identical to the one shown in [FIG. 1]. This laser effector 2 thus comprises a laser source, first optical deflection means, a lens, and second optical deflection means. In this way, the laser beam emitted by this laser effector 2 can be oriented, in particular by the second deflection means, independently of the movements of the pod 15.

This pod also carries a conventional weapon 5, such as a machine gun. Advantageously, this conventional weapon 5 can be pointed at its target by the movements of the pod 15. As the laser beam emitted by the laser effector 2 can be directed independently of the movements of the pod 15, this laser effector 2 and the conventional weapon 5 can be simultaneously aimed at two separate targets.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-10. (canceled)

11. A laser weapon comprising:
a pod,
means for orienting the pod,
at least one laser effector capable of emitting a laser beam, the at least one laser effector successively comprising, in a direction of propagation of the laser beam,
a laser source,
a first optical deflection means configured to deflect the laser beam, and
a lens configured to focus the laser beam, the lens carried by the pod, and,
control means configured to control the means for orienting the pod and the first optical deflection means,
wherein the at least one laser effector comprises a second optical deflection means configured to deflect the laser beam,
the second optical deflection means being borne by the pod and positioned after the lens, in the direction of propagation of the laser beam, and the second optical deflection means being controlled by the control means.

12. The laser weapon according to claim 11, wherein the second optical deflection means are further configured to allow controlled deflection of the laser beam over an angle greater than 3°.

13. The laser weapon according to claim 11, wherein the first optical deflection means are further configured to allow controlled deflection of the laser beam over an angular range of less than 5 milliradians.

14. The laser weapon according to claim 11, wherein the second optical deflection means comprise a plurality of prismatic blades configured to rotate about an optical axis of said the lens.

15. The laser weapon according to claim 11, wherein the second optical deflecting means comprise one or more movable reflectors.

16. The laser weapon according to claim 11, wherein the at least one laser effector comprises an optical fiber configured to conduct the laser beam between the laser source and the first optical deflection means.

17. The laser weapon according to claim 11, wherein the first optical deflection means of the at least one laser effector are borne by the pod, and
wherein the laser source of the at least one laser effector is located outside the pod.

18. The laser weapon according to claim 11, wherein the means for orienting the pod comprise a turret carrying the pod, the turret configured to pivot the pod about two axes perpendicular to each other.

19. The laser weapon according to claim 11, further comprising:
a second laser effector, the second laser effector comprising at least one lens carried by the pod.

20. The laser weapon according to claim 19, wherein the lenses of the laser effectors are oriented, on the pod, along optical axes that are not parallel to one another.
